(19) United States
(12) Patent Application Publication
(10) Pub. No.: US 2022/0312101 A1
(43) Pub. Date: Sep. 29, 2022

(54) EARPHONE

(71) Applicant: SONY GROUP CORPORATION, TOKYO (JP)

(72) Inventors: RYUTARO NAKAGAWA, TOKYO (JP); DAIZEN KOBAYASHI, TOKYO (JP); IPPEI YAMAKOSHI, TOKYO (JP); DAIGAKU KUMANO, TOKYO (JP)

(21) Appl. No.: 17/596,511

(22) PCT Filed: May 19, 2020
(86) PCT No.: PCT/JP2020/019765

§ 371 Date: Dec. 13, 2021

(30) Foreign Application Priority Data
Jun. 19, 2019 (JP) 2019-113346

(51) Int. Cl. H04R 1/10; H04R 7/12; H04R 9/04

(52) U.S. Cl. CPC H04R 1/1016; H04R 7/122; H04R 9/045

(57) ABSTRACT

This earphone includes: a housing having a ring shape and provided with a hole; a diaphragm having a first fixing portion formed near an inner peripheral edge and a second fixing portion formed near an outer peripheral edge, the diaphragm being housed in the housing; and a voice coil connected to the diaphragm. A first protrusion, a second protrusion, and a flat portion that is provided between the first protrusion and the second protrusion are formed between the first fixing portion and the second fixing portion, and the voice coil is connected to the flat portion.

### TECHNICAL FIELD

The present disclosure relates to an earphone.

### BACKGROUND ART

Patent Document 1 discloses a bone conduction earphone that is provided with a hole to allow a user to hear an external environmental sound together with music.

### CITATION LIST

### Patent Document

Patent Document 1: Japanese Patent Application Laid-Open No. 2004-208220

### SUMMARY OF THE INVENTION

### Problems to be Solved by the Invention

In general, a bone conduction earphone has a problem that sound quality is lower than that of an earphone using a diaphragm.

In view of this, an object of the present disclosure is to provide an earphone that suppresses a decrease in sound quality as much as possible.

### Solutions to Problems

The present disclosure provides, for example, an earphone including:

a housing having a ring shape and provided with a hole;

a diaphragm having a first fixing portion formed near an inner peripheral edge and a second fixing portion formed near an outer peripheral edge, the diaphragm being housed in the housing; and

a voice coil connected to the diaphragm, in which

a first protrusion, a second protrusion, and a flat portion are formed between the first fixing portion and the second fixing portion, the flat portion being provided between the first protrusion and the second protrusion, and the voice coil is connected to the flat portion.

### BRIEF DESCRIPTION OF DRAWINGS

FIG. 1 is a diagram illustrating an example of an external appearance of an earphone according to an embodiment.

FIGS. 2A and 2B are diagrams to be referred to when an example of a use state of the earphone according to the embodiment is described.

FIGS. 3A and 3B are diagrams to be referred to when a configuration example of the earphone according to the embodiment is described.

FIG. 4 is a diagram to be referred to when a configuration example of a diaphragm according to a first embodiment is described.

FIG. 5 is a sectional view of a portion of the diaphragm cut along a cutting line BB-BB in FIG. 4.

FIG. 6 is a block diagram illustrating a configuration example of a sound reproduction system to which the earphone according to the embodiment can be applied.

FIG. 7 is a diagram to be referred to when an example of an effect obtained by the first embodiment is described.

FIG. 8 is a diagram to be referred to when a configuration example of a diaphragm according to a second embodiment is described.

FIG. 9 is a sectional view of a portion of the diaphragm cut along a cutting line CC-CC in FIG. 8.

FIG. 10 is a diagram to be referred to when an example of an effect obtained by the second embodiment is described.

FIG. 11 is a diagram to be referred to when a modification of the second embodiment is described.

FIG. 12 is a diagram to be referred to when a configuration example of a diaphragm according to a third embodiment is described.

FIG. 13 is a sectional view of a portion of the diaphragm cut along a cutting line DD-DD in FIG. 12.

### MODE FOR CARRYING OUT THE INVENTION

Embodiments and the like of the present disclosure will be described below with reference to the drawings. Note that the description will be given in the following order.

<First Embodiment>

<Second Embodiment>

<Third Embodiment>

<Modifications>

The embodiments and the like described below are preferred specific examples of the present disclosure, and the content of the present disclosure is not limited to these embodiments and the like.

In particular, unless otherwise specified, any dimensions, materials, shapes, and relative arrangements of the members described in the embodiments, the description of directions such as up, bottom, left, and right, etc. are given as an example and not as a limitation of the scope of the present disclosure. Note that the sizes, the positional relationships of the members, etc. in each of drawings may be exaggerated for clarity of description, and only a part of reference numerals may be illustrated in order to prevent the illustration from being complicated. Further, in the description below, the same designations or the same reference numerals denote the same or like members and duplicative descriptions will be appropriately omitted. In addition, a plurality of structural elements of the present disclosure may be configured with the same part and as a single part which serves the purpose of a plurality of elements, and conversely, a single structural element of the present disclosure may be configured as a plurality of parts which serves the purpose of a single element.

### First Embodiment

### Example of External Appearance/Use State of Earphone

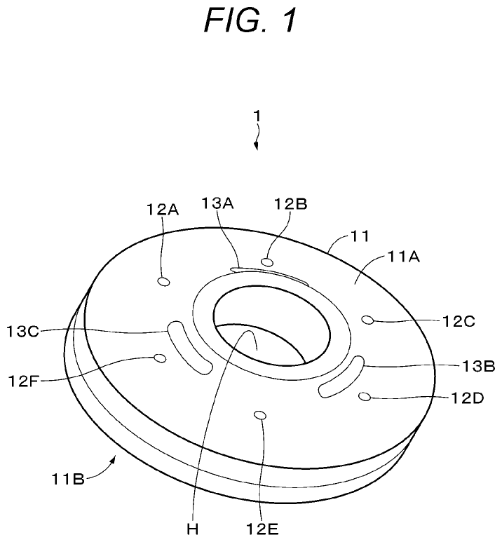

FIG. 1 is a diagram illustrating an example of an external appearance of an earphone (earphone 1) according to a first embodiment of the present disclosure. The earphone 1 according to the present embodiment is configured as a transducer of an in-ear headphone.

As shown in FIG. 1, the earphone 1 schematically has a ring shape. The earphone 1 includes a housing 11. A hole H is formed near the center of the housing 11. The housing 11 has one main surface (hereinafter referred to as a first main surface 11A as appropriate) and an opposite main surface (hereinafter referred to as a second main surface 11B as appropriate). A plurality of sound emission holes is formed in the first main surface 11A. In the present embodiment, six sound emission holes (sound emission holes 12A, 12B, . . . 12F) are formed at intervals of approximately 60 degrees in the first main surface 11A. In addition, three sound emission holes (sound emission holes 13A, 13B, and 13C) are formed at intervals of approximately 120 degrees at a position further inside the formation position of the sound emission holes 12 in the first main surface 11A. Note that, in a case where it is not necessary to distinguish the individual sound emission holes, the sound emission holes are appropriately denoted as the sound emission holes 12 or the sound emission holes 13. Sound is reproduced from the sound emission holes 12 and 13.

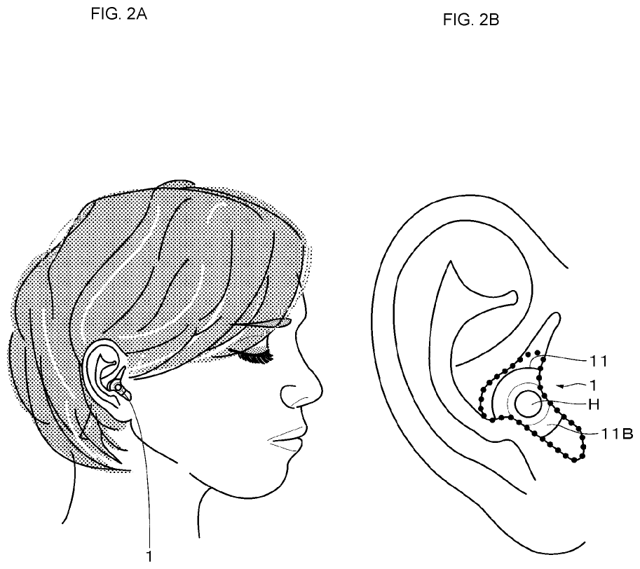

As illustrated in FIG. 2A, the earphone 1 is used by being worn on the user's ear. Specifically, as illustrated in FIG. 2B, the earphone 1 is used by being worn in a cavum conchae (a part indicated by a dotted line in FIG. 2B). More specifically, the earphone 1 is worn and used such that the first main surface 11A of the housing 11 faces the eardrum side and the second main surface 11B faces the side opposite to the eardrum (outer side).

The earphone 1 has the hole H. Therefore, external environmental sounds such as a conversation, an announcement, and a vehicle sound are taken into the ear. Thus, it is not necessary for the user to remove the earphone 1 from the ear at the time of listening to the conversation, the announcement, or the like. Furthermore, since the ear is not closed, speech, footsteps, and chewing sound are not emphasized, so that the user can continue to wear the earphone 1 in a comfortable manner. Since the earphone 1 has breathability more excellent than that of a sound-isolating earphone or a common open-air earphone, the humidity in the ear hole does not increase, so that the user can continuously wear the earphone 1 in a comfortable manner. Furthermore, by applying the earphone 1 to augmented reality (AR), the augmented hearing and the actual environmental sound naturally mix with each other, so that it is possible to give a more immersive augmented reality to the user.

### Configuration Example of Earphone

### Configuration Example of Shape

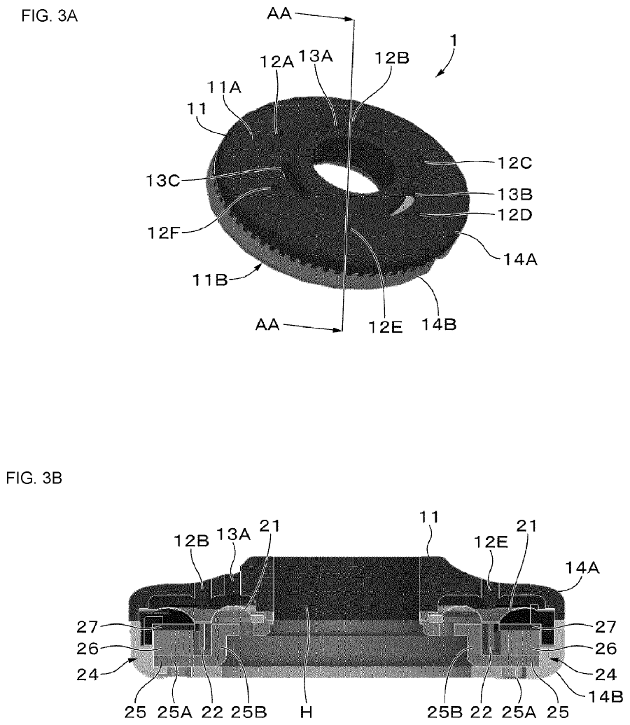

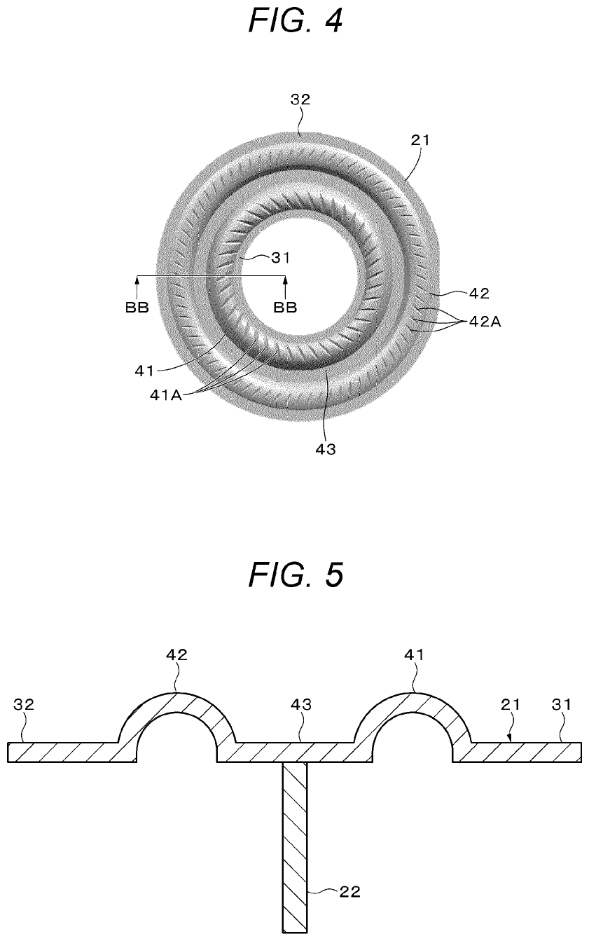

Next, a configuration example of the earphone 1 will be described with reference to FIGS. 3, 4, and 5. FIG. 3A is a perspective view illustrating the earphone 1 according to the embodiment. FIG. 3B is a diagram illustrating a cross section of a portion of the earphone 1 cut along a cutting line AA-AA in FIG. 3A. FIG. 4 is a plan view of a diaphragm according to the embodiment. FIG. 5 is a sectional view of a portion of the diaphragm cut along a cutting line BB-BB in FIG. 4.

As described above, the earphone 1 includes the housing 11. The housing 11 according to the present embodiment includes, for example, a first housing 14A and a second housing 14B. The vicinity of the center of the first housing 14A, specifically, the vicinity of the peripheral edge of the hole H, is slightly raised. The main surface of the first housing 14A corresponds to the first main surface 11A described above, and the main surface of the second housing 14B corresponds to the second main surface 11B described above. For example, the first housing 14A and the second housing 14B are integrated, and an internal space is formed in the housing 11, by engagement between a wall protruding from the vicinity of the peripheral edge of the first main surface 11A and a wall protruding from the peripheral edge of the second main surface 11B.

A diaphragm 21 is housed in the housing 11. A voice coil 22 is connected to one main surface (hereinafter referred to as a back surface as appropriate) of the diaphragm 21. The voice coil 22 is connected to the diaphragm 21 using an adhesive, a double-sided tape, or the like. The diaphragm 21 and the voice coil 22 have a ring shape so as to correspond to the shape of the housing 11. The voice coil 22 vibrates in the vertical direction in FIG. 3B according to a supplied sound signal. The vibration of the voice coil 22 is transmitted to the diaphragm 21, whereby the diaphragm 21 vibrates. As the diaphragm 21 vibrates, a sound corresponding to the sound signal is reproduced.

In addition, a magnetic circuit 24 is housed in the housing 11. The magnetic circuit 24 includes, for example, a yoke 25, a magnet 26, and a pole piece (also referred to as a top plate) 27. The yoke 25 includes a magnetic material, and has a configuration in which a flange 25A formed in a thin annular shape and an upright portion 25B erected from the vicinity of the inner peripheral end of the flange 25A are integrated.

One end surface of the magnet 26 having a ring shape is fixed on the flange 25A of the yoke 25. The pole piece 27 having a ring shape (ring-plate shape) is laid on the other end surface (upper end surface in FIG. 3B) of the magnet 26.

The voice coil 22 is inserted between the outer periphery of the upright portion 25B of the yoke 25 and the inner periphery of the magnet 26 or the pole piece 27 with a slight gap from the yoke 25 and the magnet 26 or the pole piece 27. With such an arrangement, the voice coil 22 annularly faces each of the outer periphery of the yoke 25 and each of the inner periphery of the magnet 26 or the pole piece 27.

As illustrated in FIG. 4, the diaphragm 21 has a ring shape (annular shape) as a whole. As the diaphragm 21, a soft material having relatively low rigidity can be used. Examples of the soft material include rubber, paper, metal, and thermoplastic polyurethane elastomer (TPU). The thickness of the diaphragm 21 is, for example, about 30 to 50 (μm).

As illustrated in FIGS. 4 and 5, a first fixing portion 31 is formed near the inner peripheral edge of the diaphragm 21. Further, a second fixing portion 32 is formed near the outer peripheral edge of the diaphragm 21. Each of the first fixing portion 31 and the second fixing portion 32 is bonded and fixed to an appropriate position (for example, a predetermined position of the second housing 14B) of the housing 11 with an adhesive or the like. Thus, the entire diaphragm 21 is supported in the housing 11. Note that the first fixing portion 31 and the second fixing portion 32 are appropriately set to have a size wide enough to allow adhesion.

A first protrusion 41 and a second protrusion 42 are formed between the first fixing portion 31 and the second fixing portion 32 in this order from the first fixing portion 31 side. The first protrusion 41 and the second protrusion 42 have a circular shape and protrude toward the sound emission hole 12 (see FIGS. 4 and 5). In the present embodiment, the first protrusion 41 and the second protrusion 42 have substantially the same height, but may have different heights. A flat portion 43, which is a flat region, is formed between the first protrusion 41 and the second protrusion 42. The voice coil 22 is connected to the back surface of the flat portion 43 by adhesion or the like.

As illustrated in FIG. 4, a first groove portion 41A is formed near the top part of the first protrusion 41. In addition, a second groove portion 42A is formed near the top part of the second protrusion 42. In FIG. 4, only a part of the first groove portion 41A and a part of the second groove portion 42A are denoted by reference numerals. Note that, in FIG. 5, the first groove portion 41A and the second groove portion 42A are not illustrated.

It is preferable that the orientation of the first groove portion 41A and the orientation of the second groove portion 42A are substantially opposite to each other. Being substantially opposite to each other means that the extension direction of the first groove portion 41A and the extension direction of the second groove portion 42A intersect each other, for example, intersect at a predetermined position on the flat portion 43. By setting the orientation of the first groove portion 41A and the orientation of the second groove portion 42A to be substantially opposite to each other, it is possible to effectively suppress the occurrence of rolling of the diaphragm 21.

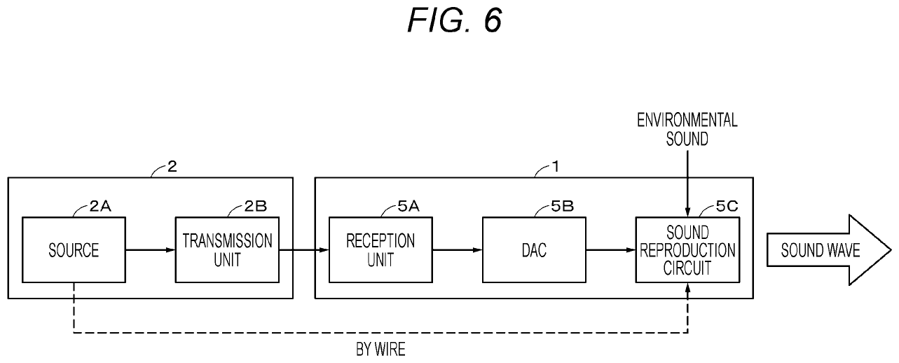

(Example of electrical configuration) FIG. 6 is a block diagram illustrating a configuration example of a sound reproduction system to which the earphone 1 according to the embodiment can be applied. The earphone 1 performs wireless communication with a sound reproduction apparatus 2. Wireless communication based on, for example, Bluetooth (registered trademark) is performed between the earphone 1 and the sound reproduction apparatus 2.

The sound reproduction apparatus 2 includes a source 2A of a sound signal and a transmission unit 2B. Anything may be used for the source 2A, such as an optical disk, a semiconductor memory, or network distribution. A sound signal obtained by performing appropriate signal processing such as compression processing or modulation processing on the sound signal of the source 2A is transmitted from the transmission unit 2B to the earphone 1.

The earphone 1 includes, as an electrical configuration, a reception unit 5A, a digital analog converter (DAC) 5B, and a sound reproduction circuit 5C. The sound signal transmitted from the sound reproduction apparatus 2 is received by the reception unit 5A of the earphone 1. The sound signal received by the reception unit 5A is subjected to appropriate signal processing such as demodulation processing. The sound signal subjected to the signal processing is converted from a digital format to an analog format by the DAC 5B. The sound signal converted into an analog format is supplied to the sound reproduction circuit 5C. The sound reproduction circuit 5C is a circuit for sound reproduction including the magnetic circuit 24 described above. The diaphragm 21 vibrates on the basis of the sound signal supplied to the sound reproduction circuit 5C to generate a sound wave, whereby a sound corresponding to the sound signal is reproduced. Furthermore, as described above, the external environmental sound is taken into the ear hole via the hole H, and thus, the external environmental sound can be heard by the user.

Note that the earphone 1 and the sound reproduction apparatus 2 may be connected by wire via a cable. Then, the sound signal may be transmitted from the sound reproduction apparatus 2 to the earphone 1 via the cable. In such a configuration example, the sound signal is transmitted from the source 2A to the sound reproduction circuit 5C via the cable as indicated by a dotted line in FIG. 6. In the case of digital transmission, the sound signal is supplied from the source 2A to the DAC 5B.

### Effects Obtained by the Present Embodiment

In the present embodiment, a soft material is used for the diaphragm 21, whereby a resonance frequency f₀ can be lowered. For example, the resonance frequency f₀ can be set to 300 Hz or less. Therefore, it is possible to increase sensitivity in a low frequency band during reproduction by the earphone 1.

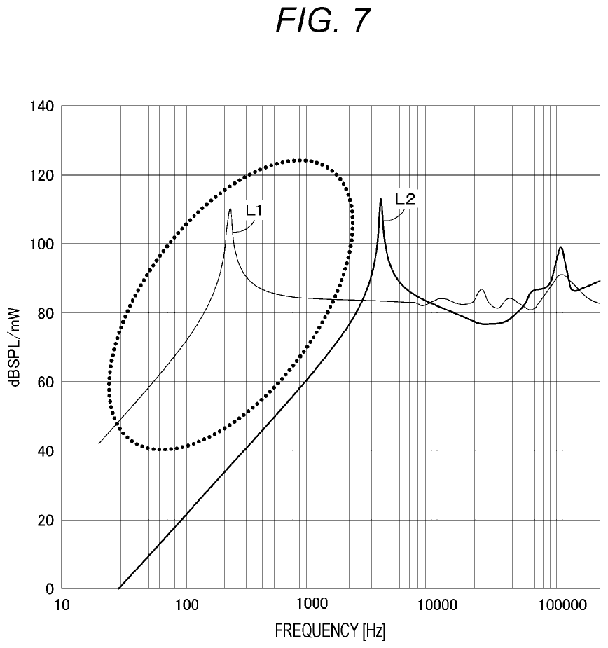

FIG. 7 is a diagram (graph) for describing an example of an effect obtained by the present embodiment. In the graph of FIG. 7, the horizontal axis represents frequency, and the vertical axis represents sound pressure level (SPL). A line L1 in FIG. 7 indicates frequency characteristics of the diaphragm 21 according to the present embodiment. In addition, a line L2 indicates frequency characteristics of a comparative diaphragm which includes a material having higher rigidity than the diaphragm 21. Note that, as the diaphragm 21 having the frequency characteristics indicated by the line L1 in FIG. 7, a diaphragm using TPU as a material and having a hardness of 70 to 85 [A] and a thickness of about 30 to 50 [μm] is assumed. On the other hand, the comparative diaphragm having the frequency characteristics indicated by the line L2 is assumed to use a material having hardness about 1.5 to 2 times that of the diaphragm 21. As indicated in an area surrounded by a dotted ellipse in FIG. 7, it is possible to improve the sensitivity in a low frequency band more than that of the comparative diaphragm by applying a soft material as the material of the diaphragm 21.

Generally, in the configuration in which the hole H is formed as in the earphone 1, the area of the diaphragm 21 is reduced, so that the sound pressure may be reduced. However, in the diaphragm 21 according to the present embodiment, the first protrusion 41 and the second protrusion 42 are formed, whereby the diaphragm 21 is easily bent, and a decrease in sound pressure can be suppressed.

In addition, by providing the first groove portion 41A and the second groove portion 42A, it is possible to distribute stress concentrated near the top parts of the first protrusion 41 and the second protrusion 42, whereby the diaphragm 21 can be efficiently operated.

### Second Embodiment

Next, a second embodiment will be described. Note that the matters described in the first embodiment can be applied to the second embodiment unless otherwise specified.

As described in the first embodiment, a sound pressure can be ensured by using a soft material for the diaphragm. On the other hand, when a voice coil is directly connected to the diaphragm which uses a soft material, split vibration is likely to occur at a neck portion near a connection portion, which may cause deterioration in sound quality (in particular, loss in a high frequency band). In view of this, in the present embodiment, a reinforcing member is interposed between the diaphragm and the voice coil. Such a reinforcing member can effectively transmit vibration of the voice coil to the diaphragm.

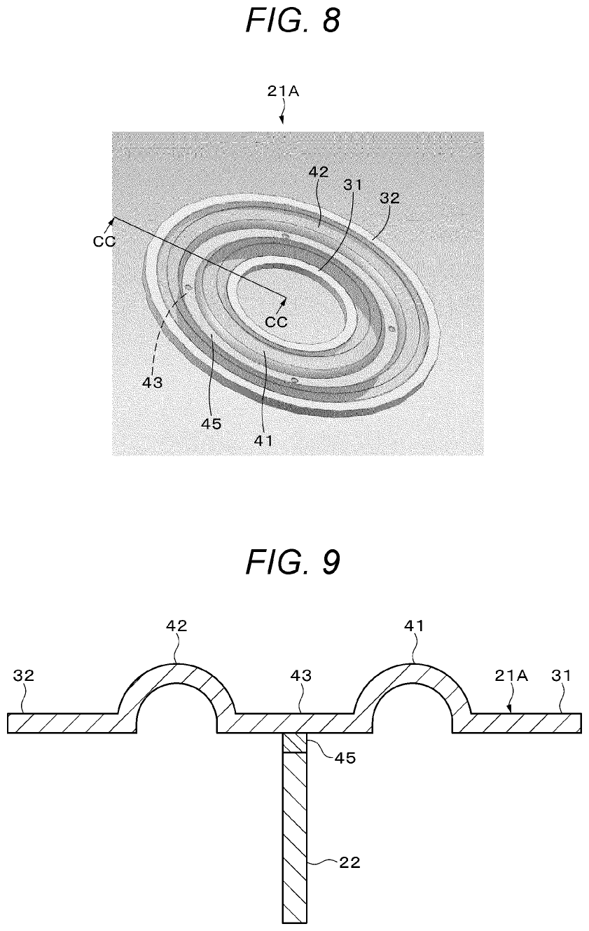

FIG. 8 is a perspective view of a diaphragm (diaphragm 21A) according to the second embodiment as viewed from the back surface side. In FIG. 8, the voice coil 22 is not illustrated. FIG. 9 is a sectional view of a portion of the diaphragm 21A cut along a cutting line CC-CC in FIG. 8. In FIG. 9, the cross section is turned upside down for easy understanding.

The diaphragm 21A is different from the diaphragm 21 in configuration in that a reinforcing member 45 is attached to the back surface of the flat portion 43 of the diaphragm 21A, and the boil coil 22 is connected to the reinforcing member 45.

The reinforcing member 45 preferably includes a material having rigidity higher than rigidity of the diaphragm 21A in order to effectively transmit vibration of the voice coil 22. Specific examples of the reinforcing member 45 include paper (including Japanese paper, shoji paper, and the like), foam such as sponge, and metal foil such as aluminum foil.

When the reinforcing member 45 is provided between the flat portion 43 of the diaphragm 21A and the voice coil 22 to increase the thickness of the flat portion 43, it is possible to suppress the split vibration and to prevent a decrease in the level of a high frequency band.

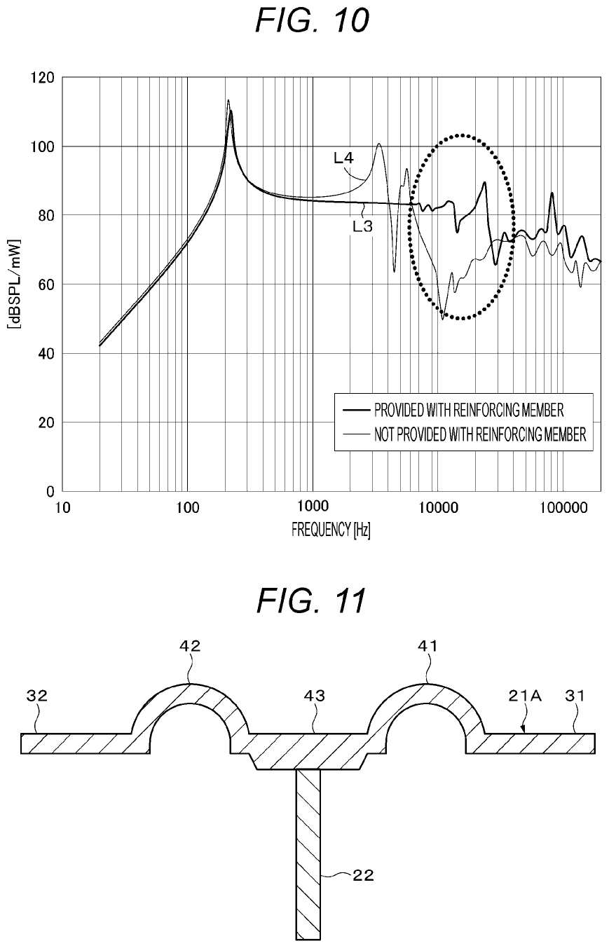

FIG. 10 illustrates frequency characteristics of diaphragms 21A which are the same in material and thickness, but are different from each other only in that one of them has a reinforcing member, and the other does not have a reinforcing member. In the graph of FIG. 10, the horizontal axis represents frequency, and the vertical axis represents sound pressure level. In addition, a line L3 in the graph of FIG. 10 indicates frequency characteristics of the diaphragm 21A provided with the reinforcing member 45, and a line L4 in the graph of FIG. 10 indicates frequency characteristics of the diaphragm 21A without the reinforcing member 45. As indicated in an area surrounded by a dotted ellipse in FIG. 10, a decrease in the sensitivity in the high frequency band is suppressed due to the reinforcing member 45 being provided.

Note that, as illustrated in FIG. 11, the thickness of the flat portion 43 of the diaphragm 21A may be set larger than the thicknesses of other portions without providing the reinforcing member 45. With such a configuration, it is also possible to suppress the occurrence of split vibration in the neck portion, and thus, it is possible to prevent a decrease in the sensitivity in the high frequency band.

### Third Embodiment

Next, a third embodiment will be described. Note that the matters described in the first and second embodiments can be applied to the second embodiment unless otherwise specified.

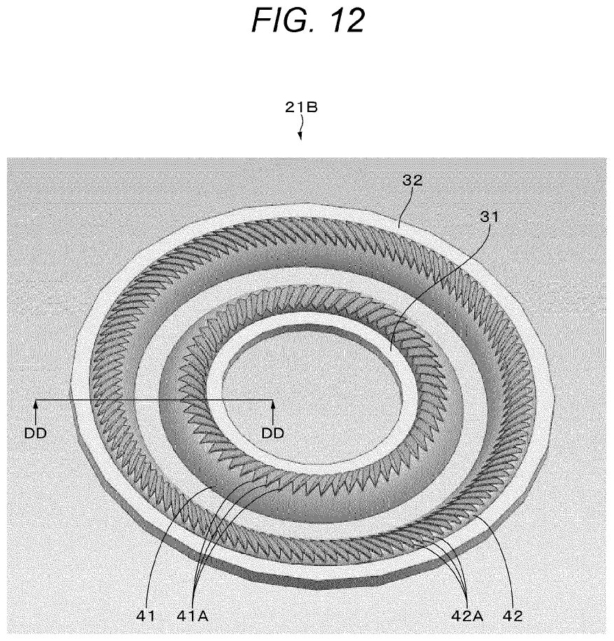

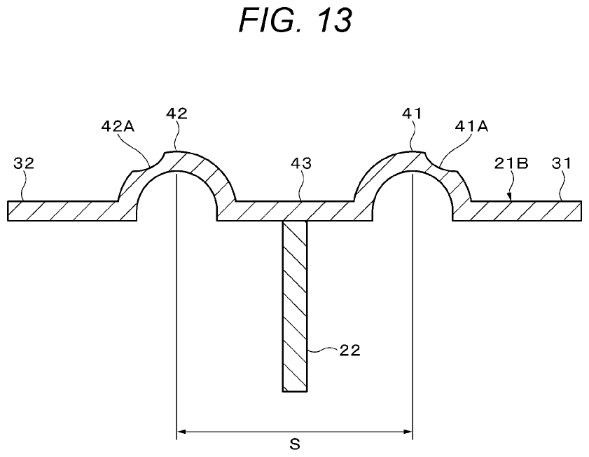

FIG. 12 is a perspective view of a diaphragm (diaphragm 21B) according to the third embodiment as viewed from the front surface (reverse to the back surface) side. FIG. 13 is a sectional view of a portion of the diaphragm 21B cut along a cutting line DD-DD in FIG. 12.

Similar to the diaphragm 21 according to the first embodiment, the diaphragm 21B includes a first protrusion 41 and a second protrusion 42. In addition, a first groove portion 41A is formed in the first protrusion 41, and a second groove portion 42A is formed in the second protrusion 42.

The first groove portion 41A in the present embodiment is formed in a region of the first protrusion 41 closer to the first fixing portion 31. The term “being closer to the first fixing portion 31” means that, in the area of predetermined grooves constituting the first groove portion 41A, the area on the first fixing portion 31 side with respect to the top part of the first protrusion 41 is larger than the area on the opposite side. From the viewpoint of increasing an effective area S to be described later, it is preferable that all of the predetermined grooves constituting the first groove portion 41A are located closer to the first fixing portion 31.

In addition, the second groove portion 42A is formed in a region of the second protrusion 42 closer to the second fixing portion 32. The term “being closer to the second fixing portion 32” means that, in the area of predetermined grooves constituting the second groove portion 42A, the area on the second fixing portion 32 side with respect to the top part of the second protrusion 42 is larger than the area on the opposite side. From the viewpoint of increasing the effective area S to be described later, it is preferable that all of the predetermined grooves constituting the second groove portion 41B are located closer to the second fixing portion 32.

With this configuration, the effective area S of the diaphragm 21B can be increased. The effective area S is defined by, for example, an area of a portion that contributes to sound pressure due to vibration of the diaphragm 21B, specifically, the area of a portion close to the neck portion and having no groove portion in the areas of the first protrusion 41, the second protrusion 42, and the flat portion 43. According to the present embodiment, since the effective area S of the diaphragm 21B can be maximized, the sound pressure can be ensured.

<Modifications>

While the plurality of embodiments of the present disclosure have been specifically described above, the present disclosure is not limited to the above-described embodiments, and various modifications based on the technical concept of the present disclosure are possible.

Although the earphone according to each of the above embodiments has a ring shape, the earphone may have a triangular shape or a rectangular shape. In addition, the number of protrusions and grooves can be set to an appropriate number.

The configurations, methods, steps, shapes, materials, numerical values, and the like described in the above embodiments are merely examples, and different configurations, methods, steps, shapes, materials, numerical values, and the like may be used as necessary. The above embodiments and modifications can be appropriately combined.

Note that the content of the present disclosure is not to be construed as being limited by the effects described in the present disclosure.

The present disclosure can also be configured as follows.

(1)

An earphone including:

a housing having a ring shape and provided with a hole;

a diaphragm having a first fixing portion formed near an inner peripheral edge and a second fixing portion formed near an outer peripheral edge, the diaphragm being housed in the housing; and

a voice coil connected to the diaphragm, in which

a first protrusion, a second protrusion, and a flat portion are formed between the first fixing portion and the second fixing portion, the flat portion being provided between the first protrusion and the second protrusion, and the voice coil is connected to the flat portion.

(2)

The earphone according to (1), in which

a reinforcing member is interposed between the flat portion and the voice coil.

(3)

The earphone according to (2), in which

the reinforcing member has rigidity greater than rigidity of the diaphragm.

(4)

The earphone according to (2) or (3), in which

the reinforcing member includes any of paper, foam, and metal foil.

(5)

The earphone according to (1), in which

the flat portion of the diaphragm has a thickness set to be larger than thicknesses of other portions of the diaphragm.

(6)

The earphone according to any one of (1) to (5), in which

the first protrusion is formed with a first groove portion, and the second protrusion is formed with a second groove portion.

(7)

The earphone according to (6), in which

the first groove portion has an orientation substantially opposite to an orientation of the second groove portion.

(8)

The earphone according to (6) or (7), in which

the first groove portion is located closer to the first fixing portion, and the second groove portion is located closer to the second fixing portion.

(9)

The earphone according to any one of (1) to (8), in which

the first fixing portion and the second fixing portion are fixed to a predetermined position of the housing.

### REFERENCE SIGNS LIST

1 Earphone
11 Housing
21, 21A, 21B Diaphragm
22 Voice coil
24 Magnetic circuit
31 First fixing portion
32 Second fixing portion
41 First protrusion
41A First groove portion
42 Second protrusion
42A Second groove portion
43 Flat portion
45 Reinforcing member
H Hole

1. An earphone comprising:
a housing having a ring shape and provided with a hole;
a diaphragm having a first fixing portion formed near an inner peripheral edge and a second fixing portion formed near an outer peripheral edge, the diaphragm being housed in the housing; and
a voice coil connected to the diaphragm, wherein
a first protrusion, a second protrusion, and a flat portion are formed between the first fixing portion and the second fixing portion, the flat portion being provided between the first protrusion and the second protrusion, and the voice coil is connected to the flat portion.

2. The earphone according to claim 1, wherein
a reinforcing member is interposed between the flat portion and the voice coil.

3. The earphone according to claim 2, wherein
the reinforcing member has rigidity greater than rigidity of the diaphragm.

4. The earphone according to claim 2, wherein
the reinforcing member includes any of paper, foam, and metal foil.

5. The earphone according to claim 1, wherein
the flat portion of the diaphragm has a thickness set to be larger than thicknesses of other portions of the diaphragm.

6. The earphone according to claim 1, wherein
the first protrusion is formed with a first groove portion, and the second protrusion is formed with a second groove portion.

7. The earphone according to claim 6, wherein
the first groove portion has an orientation substantially opposite to an orientation of the second groove portion.

8. The earphone according to claim 6, wherein
the first groove portion is located closer to the first fixing portion, and the second groove portion is located closer to the second fixing portion.

9. The earphone according to claim 1, wherein
the first fixing portion and the second fixing portion are fixed to a predetermined position of the housing.
